(19) United States
(12) Patent Application Publication
(10) Pub. No.: US 2018/0128914 A1
(43) Pub. Date: May 10, 2018

(54) System And Method For Estimating The Yield Of A Cultivated Plot

(71) Applicant: Ovalie Innovation, Auch (FR)

(72) Inventors: Thierry Veronese, Lautignac (FR); Dominique Henry, Toulouse (FR); Herve Aubert, Toulouse (FR)

(73) Assignee: Ovalie Innovation, Auch (FR)

(21) Appl. No.: 15/570,576

(22) PCT Filed: Apr. 29, 2016
(86) PCT No.: PCT/EP2016/059697

§ 371 Date: Oct. 30, 2017

(30) Foreign Application Priority Data
Apr. 30, 2015 (FR) 1553929

(51) Int. Cl. G01S 13/90

(52) U.S. Cl. CPC G01S 13/90; G01S 7/35

(57) ABSTRACT

The invention relates to a system for estimating the agricultural yield of a cultivated plot comprising a plurality of crops, the system comprising: —a radar unit (1) having: —a radar (11) configured to acquire at least one image of the cultivated plot, said radar operating in the field of frequency-modulated continuous waves; —a focusing unit (12) configured to focus a radar beam in an acquisition direction; a processing unit (2) configured to carry out steps of: acquiring (E1), for each position of the radar; processing (E2) the acquired image to extract therefrom at least one data item representative of the yield of the cultivated plot; determining (E3) the yield of the cultivated crop on the basis of the extracted data.

### GENERAL TECHNICAL FIELD

The invention relates to the field of radar imaging applied to agriculture and especially the field of fruits and vegetables in the interests of knowing their yields before harvest.

### PRIOR ART

In the field of agriculture, farm operators need to estimate the crop yield of a cultivated plot to evaluate the nature of the harvest. It is specified that crop yield is a quantity of harvested product brought to a surface unit of a given cultivated plot (Ex: tons/hectare, quintals/ha).

In particular, in the field of growing fruit or vegetable it is interesting for an operator to be able to rapidly and precisely gather data such as the quantity of fruits or vegetables, the weight of each at different stages of development (formation, plateau and maturity) to set up mapping of yield plot by plot and/or inside the same farm plot and so to forecast up to one or two months in advance what harvests will return.

For this purpose, a solution is known according to which a pedestrian travels over a plot of a cultivated field and by means of a dedicated sensor measures the weight of several fruits/vegetables and their number to determine the yield of the cultivated plot.

Such a solution is restrictive and unreliable. Also, this solution can damage/destroy fruits/vegetables or entail stripping leaves off plants to let the operator and the sensor visually access the fruits.

### PRESENTATION OF THE INVENTION

One of the aims of the invention is to propose a solution which estimates yield of a farm plot. For this purpose, according to a first aspect the invention proposes a system for estimating the crop yield of a cultivated plot comprising a plurality of crops, the system comprising:
a radar unit comprising:
a radar configured for acquiring at least one image of the cultivated plot, said radar operating in the field of frequency-modulated continuous waves;
a focusing unit configured to focus a beam coming from the radar in a direction of acquisition;
a processing unit configured to conduct steps of:
acquisition of at least one image of at least one crop by means of the radar;
processing of the acquired image to extract from it at least one datum representative of the yield of the cultivated plot;
determination of the yield of the cultivated plot from the extracted data.

In addition, the acquisition system can comprise a unit for moving the radar configured to move the radar in the cultivated plot from one position to another so as to obtain images of at least one crop for each position of the radar, the radar scanning the cultivated plot from each position.

The focusing device can be constituted by a reflector antenna or an electromagnetic lens or an antenna array.

The radar unit preferably operates in a frequency band comprised between 24 GHz and 80 GHz.

According to another aspect, the invention relates to a method for estimating the crop yield of a cultivated plot comprising a plurality of crops by means of a system according to the invention, the method comprising steps of:
acquisition of at least one image of at least one crop of the cultivated plot by means of the radar unit;
processing of the acquired image to extract from it at least one datum representative of the yield of the cultivated plot;
determination of the yield of the cultivated plot from the number of crops and their plot.

By way of advantage, the data representative of the yield comprise: a number of crops present on the image and/or the size of each crop and/or, the volume of each crop, the weight of each crop.

Also, the acquisition can consist of moving the radar in the cultivated plot from one position to another so as to obtain images of crop(s) for each position of the radar, the radar scanning the cultivated plot from each position.

The acquired image is preferably constituted by several different contrast areas, the processing of the acquired image consisting of identifying areas which correspond to a crop.

According to a final aspect, the invention relates to the use of a method according to the invention for estimating the crop yield of a plot of fruits or vegetables.

The invention rapidly and precisely gathers data to anticipate what harvests will return in terms of overall volume (yield) and associated quality.

Also, the invention does not damage fruits/vegetables and trees, plants or stocks as it is performed without contact (remotely) and without stripping off leaves.

Therefore, the invention can provide all participants in the agricultural sector involved in estimation of yield with a reliable and fast system and method enabling early forecasting.

Applied to viticulture, the invention especially rapidly and precisely gathers data such as quantity of grapes on grapevines, the weight of bunches at different stages in development (formation, plateau and maturity) and therefore forecast up to one or two months in advance what the picking on plots of several thousands of stocks will return and the harvest strategies and transport/storage logistics which will be developed.

In fact, in the field of viticulture, having a system and a method capable of rapidly and precisely gathering data such as quantity of grapes on vines is a key asset for the relevant enterprise. Such a system, for a wine specialist, in fact finds out the weight of bunches at different stages of development (formation, plateau and maturity) and forecast up to one or two months in advance what picking on plots of several thousands of stocks will return.

The same logic can apply to any type of fruit or vegetable growing.

### PRESENTATION OF THE FIGURES

Other characteristics, aims and advantages of the invention will emerge from the following description which is purely illustrative and non-limiting and which must be viewed in conjunction with the appended drawings, in which:

FIG. 1 illustrates a system for estimating the crop yield of a cultivated plot;

FIG. 2 illustrates steps of a method for estimating the crop yield of a cultivated plot;

FIG. 3 illustrates a cultivated plot;

FIG. 4 illustrates an image acquired during a method for estimating the crop yield of a cultivated plot;

FIG. 5 illustrates a vine stock of a cultivated plot.

In all figures, similar elements bear identical reference numerals.

### DETAILED DESCRIPTION OF THE INVENTION

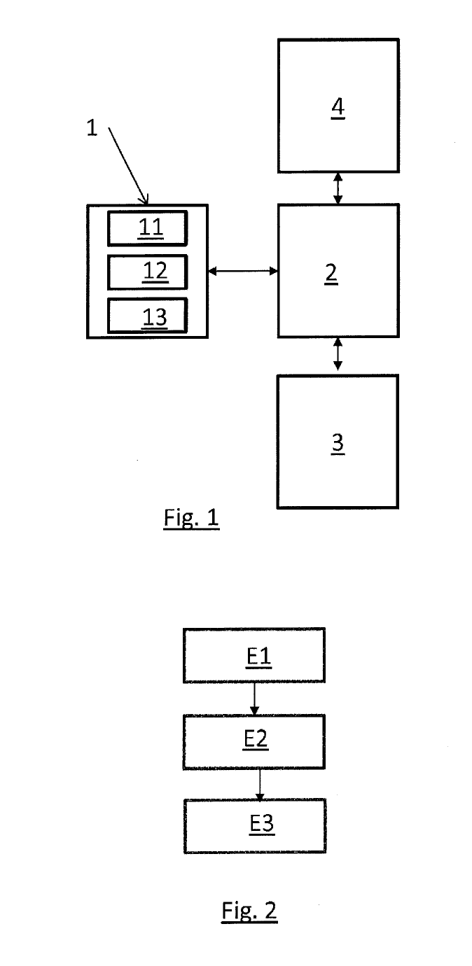

FIG. 1 illustrates a system for estimating the crop yield of a cultivated plot comprising a radar unit 1 configured for acquiring at least one three-dimensional (3D) or bidimensional (2D) image of the cultivated plot. The radar unit therefore comprises a radar 11 configured to operate in the field of millimetric waves or microwaves and on wide frequency band. The radar preferably operates in the field of frequency-modulated continuous waves (FMCW).

Also, the radar unit 1 comprises a focus unit 12 (not shown) which focuses the beam emitted by the radar in a direction of acquisition. Such focusing favours counting to obtain the yield of the plot (see hereinbelow). Such a focus unit 12 is constituted by a reflector antenna (parabolic, for example), electromagnetic lens or an antenna array.

The radar unit 1 is preferably configured to be disposed at ground level of the plot so it can image the crops of the plot. It is understood here that the radar unit 1 is at the height of the crops (and not above as for known techniques of satellite radar imaging).

In addition, the system further comprises a unit (13) for moving the radar configured to move the radar in the cultivated plot from one position to another so as to obtain images of at least one crop for each position of the radar, the radar scanning the cultivated plot from each position and making at least one acquisition from each position.

The moving unit 13 is mechanical or electronic (see hereinbelow).

The system further comprises a processing unit 2 configured to perform steps of a method for estimating the crop yield of a cultivated plot which will be described hereinbelow.

This system further comprises a memory 3 which stores images acquired by the radar 1 and software which controls the processing unit 2 so that it executes the method for estimating the crop yield of a cultivated plot. The system further comprises optionally an interaction tool 4 with a user enabling an operator to view acquired images, to re-enter data or parameterize the software. This is for example a keyboard linked to a screen.

In particular, the radar unit 1 operates in a frequency band centered on 24 GHz or 77 GHz or even higher frequencies (120 GHz for example). The radar unit is an electronic or mechanical scanning unit and moves (translation movement for example) to increase the spatial resolution of the measurement. This technique of radar imaging is known as the SAR method (Synthetic Aperture Radar). Although widely used by satellite imagers it has never been applied to estimation of crop yield of a cultivated plot.

The use of the radar unit 1 has the advantage of having no contact with crops present on the cultivated plot such that they are not damaged during the different measurements.

In relation to FIG. 2, a method for estimating the crop yield of a cultivated plot comprises the steps described hereinbelow.

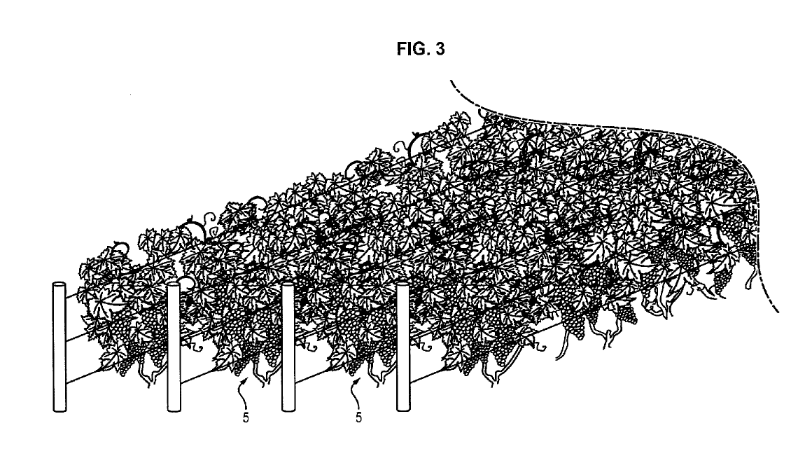

FIG. 3 illustrates a cultivated plot which by way of non-limiting example comprises vine stocks planted according to several rows.

The method comprises a first step E1 of acquisition of at least one three-dimensional image of the cultivated plot by means of the radar unit 1. The radar unit is placed on the ground near the cultivated plot. It is placed especially at a point where it can best acquire the cultivated plot.

In particular, acquisition step E1 consists of scanning the cultivated plot for which the yield is to be estimated.

An image acquired by the radar unit is typically bidimensional (2D) or three-dimensional (3D).

Also, the acquired image comprises several contrast areas. This image is a spatial representation of the level of the radar echo (or electromagnetic backscattering) at any point in a space illuminated by the wave emitted by the radar unit.

When a point in this space here called pixel strongly backscatters this wave, it appears as a shining point in the image, whereas a low-reflective pixel is viewed as a dark point in this image.

For example, a bunch of grapes (or a collection of bunches of grapes) will therefore be seen as a compact collection of shining points occupying a certain volume in the radar image. This volume is correlated to the physical volume of the bunch (or the collection of bunches) such that in principle its measuring deduces the physical volume of the bunch (or the collection of bunches). Processing the radar image (cf. the SAR method) minimizes the impact of clutter, such as for example greenery, stakes, wires, or wooded areas (vine stocks), on the estimation of pertinent volume. This contactless estimation technique of volume applies to any other fruit or vegetable as a function of the relevant cultivated plot.

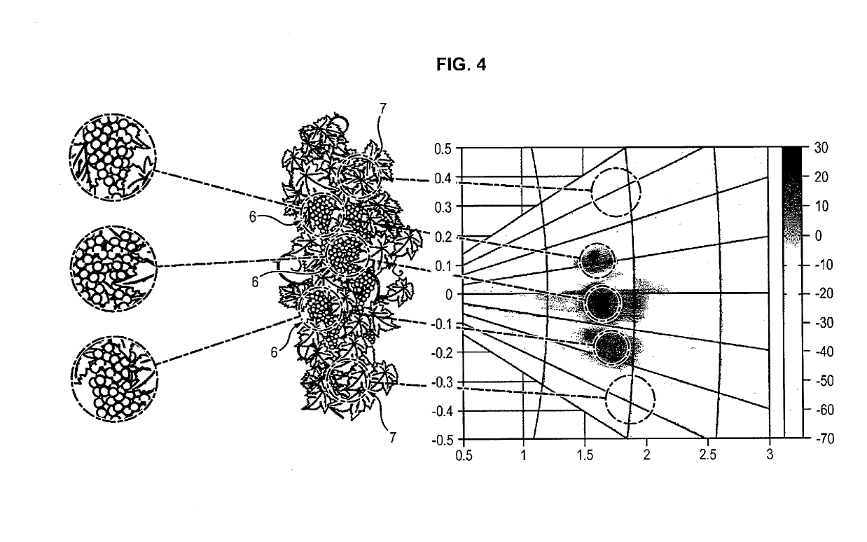

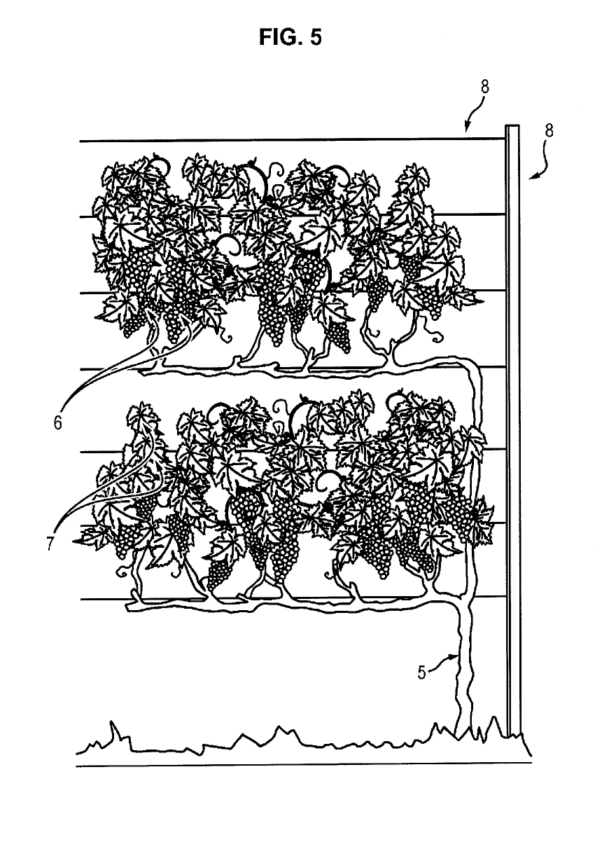

FIG. 4 illustrates a 2D image acquired during the method and FIG. 5 illustrates a vine stock comprising greenery 7 and bunches 3 and all infrastructures 8 needed for good growing.

In FIG. 4, the radar image to the right is that of greenery comprising three bunches 6 of grapes. The signature or radar echo of the greenery 7 can be measured but has a lower intensity than that of the three bunches 6.

This acquired image is processed to extract from it data representative of the yield of the cultivated plot in a second step E2. This step consists of applying the SAR method (Synthetic Aperture Radar) which benefits from scanning (mechanical or electronic) of the antenna of the radar to boost the contrast between signature radar of the target of interest (for example the bunch of grapes) and that of its environment. This scanning can be combined with translation movement of the antenna to further heighten the resolution of the distance measurement of volume.

Data representative of the yield are especially: a number of crops present on the cultivated plot and/or the size of each plot and/or the weight of each crop.

In viticulture, the general definition of the yield is the weight of the harvest per surface unit, hectare. On the vine stock scale, the components of the weight of harvest are the number of bunches, the average number of berries per bunch and the average weight of berries. On the hectare scale, the number of stocks is added to these components.

Advantageously, acquisition consists of moving the radar in the cultivated plot from one position to another position so as to obtain images of crop(s) for each position of the radar, the radar scanning the cultivated plot from each position.

Accordingly, the radar is movable in the cultivated plot according to two possible configurations:
according to a first configuration: the radar is stationary and placed in front of a collection of crops (for example grape vines), the latter performs mechanical or electronic scanning to take a radar image of the scene from which the yield will be estimated (in particular, the volume of bunches of grape vines). Once the image is acquired, the radar will be moved by a few meters (for example, along a furrow) and will proceed to acquire a new image and so on. This configuration is called step by step;
according to a second configuration: the radar will be movable and placed on a moving vehicle (for example, along a furrow): the radar will scan the scene and undergo any bumping linked to moving the vehicle carrying the radar. This configuration is known as dynamic.

For moving the radar, provision could be made to place the radar on a vehicle or movable robot (remote-controlled or motorized with driver of quad type, in any case the vehicle is to be adapted to move in the cultivated plot). The radar is fitted with a device for precisely pinpointing its displacement to take this into account during processing of the image.

The method comprises a third step E3 for determining the yield of the cultivated plot. Here it is counting the crops on each acquired image and the yield is obtained especially by the following product: volume of a crop×number of crops (fruit or vegetable) per surface unit (m², Ha)×size of the cultivated plot×density of the crop (fruit or vegetable).

And in particular, for grapes, the yield is obtained by the following product: number of bunches×weight of the bunch×cultivated plot.

The weight of the bunch is especially an extrapolation of the extracted data as a function of the age of the cultivated plot. The weight of the bunch or the fruit results from measuring, or the correspondence between the volume estimated by the radar and the known density of the measured products. The weight can be obtained from a databank of consequent or calculated data from a growth factor of the crops here too based on average historic results (minimum of 10 years).

So, counting crops consists of scanning the scene (mechanically or electronically) by the very narrow focused beam coming from the radar. In the direction of the beam the density of electromagnetic power is very high, whereas in the other spatial directions it is much weaker (an antenna having a strong capacity to focus on the density of electromagnetic power in a direction datum is called directive).

The wave focused in a spatial direction is backscattered essentially by the targets (fruits, leaves, trunks, branches . . . ) intercepted in this direction.

In fact, the targets found in the other directions contribute little to the echo since these targets are in principle weakly illuminated by the wave emitted by the radar.

When the echo is strong at a point located in this direction, this means that the wave has intercepted the surface of an object: to estimate the size of the object detected in this way it suffices to point the beam of the emitting antenna of the radar slightly to the side until this echo dies out.

The emission beam scans the entire scene to enable automatic acquisition of a radar image comprising all the echoes from all points of the scene. The size and number of objects backscattering in the scene can be deduced in principle from this radar image.

1. A system for estimating the crop yield of a cultivated plot comprising a plurality of crops, the system comprising:
a radar unit comprising:
a radar configured for acquiring at least one image of the cultivated plot, said radar operating in the field of frequency-modulated continuous waves;
a focusing unit configured to focus a beam coming from the radar in a direction of acquisition;
a processing unit configured to conduct steps of:
acquisition (E1) of at least one image of at least one crop by means of the radar;
processing (E2) of the acquired image to extract from it at least one datum representative of the yield of the cultivated plot;
determination (E3) of the yield of the cultivated plot from the extracted data.

2. The acquisition system according to claim 1, comprising a unit for moving the radar configured to move the radar in the cultivated plot from one position to another so as to obtain images of at least one crop for each position of the radar, the radar scanning the cultivated plot from each position.

3. The system according to claim 1, wherein the focusing unit is constituted by a reflector antenna or an electromagnetic lens or an antenna array.

4. The system according to claim 1, wherein the radar unit operates in a frequency band comprised between 24 GHz and 80 GHz.

5. A method for estimating the crop yield of a cultivated plot comprising a plurality of crops by means of a system according to claim 1, the method comprising steps of:
acquisition (E1) of at least one image of at least one crop of the cultivated plot by means of the radar unit;
processing (E2) of the acquired image to extract from it at least one datum representative of the yield of the cultivated plot;
determination (E3) of the yield of the cultivated plot from the number of crops and their plot.

6. The method according to claim 5, wherein the data representative of the yield comprise: a number of crops present on the image and/or the size of each crop and/or, the volume of each crop, the weight of each crop.

7. The estimation method according to claim 5, wherein acquisition consists of moving the radar in the cultivated plot from one position to another so as to obtain images of crop(s) for each position of the radar, the radar scanning the cultivated plot from each position.

8. The estimation method according to claim 5, wherein the acquired image is constituted by several different contrast areas, the processing of the acquired image consisting of identifying areas which correspond to a crop.

9. Use of a method according to claim 5, for estimating the crop yield of a plot of fruits or vegetables.
